(19) United States
(12) Patent Application Publication
(10) Pub. No.: US 2013/0037038 A1
(43) Pub. Date: Feb. 14, 2013

(54) La lengua

(71) Applicant: Christopher Smith, Queens, NY (US)

(72) Inventor: Christopher Smith, Queens, NY (US)

(21) Appl. No.: 13/566,183

(22) Filed: Aug. 3, 2012

Related U.S. Application Data
(60) Provisional application No. 61/522,866, filed on Aug. 12, 2011.

(51) Int. Cl. A61C 5/14; A42B 1/04

(52) U.S. Cl. 128/859; 2/206

(57) ABSTRACT

The Present invention relates to children who have a problem expressing themselves. Boys tend to bottle things up inside. This invention will help them be more expressive in their daily lives. We make this toy by using mold gel alginate; it is placed over one of our models face. When it starts to gel we apply a second coat over the mouth. We, then remove and create airways. The invention comes in various colors.

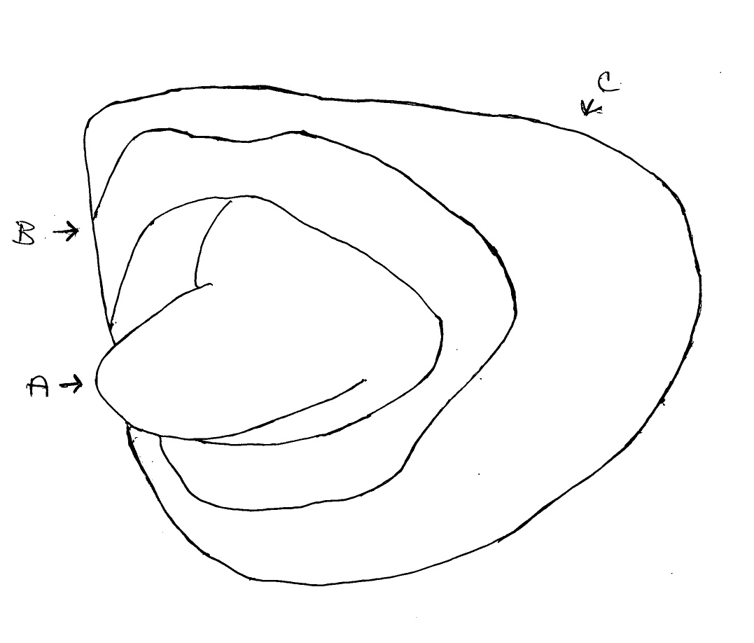

### SPECIFICATION

This application claim priority to the provisional application 13/566,183 filing date Aug. 12, 2011.

### BACKGROUND

Arts and Craft. This invention, the tongue is placed over the lower portion of the face. It comes in various colors to resemble whatever holiday or occasion. It does not in any way impede the user's ability to breathe. This invention is a toy for kids. To help them get into arts and crafts. This invention is for show. It does not do anything physically but mentally it is designed to get kids to be more expressive. The tongue is made of mold gel alginate.

### SUMMARY OF INVENTION

This invention is made using mold gel alginate; this invention is made using the following: Mold gel alginate is used to cast the lower jaw. Mold gel alginate gels quickly and is safe to use on the human body. As the Alginate gels the model is told to open his/her mouth then, another coat of alginate gel is applied across the mouth just before it's dried. The alginate mask is then removed and airways are made.

### DESCRIPTION

While the specification concludes with claims particularly pointing out and distinctly claiming the subject matter which is regarded as the invention, the objects and features of the invention and further objects, features and advantages thereof will be better understood from the description taken in connection with the accompanying drawing in which a sole figure shows an Illustration of the invention. The figure is an illustration of the front of the device.

### DETAIL DESCRIPTION OF THE INVENTION

Arrow A. The tongue of the device. Arrow B. The lips of the invention. Arrow C. Surrounding area of invention, Covers the cheeks of the wearer.

1-3. (canceled)

4. Device that is latex based material that covers the lower portion of the face to protect against venereal disease. It is attached by perforated tape around the edges to the users face.

5. The device of claim 4 that is latex based and protects against venereal disease with vibrating raised ridges. It is attached by perforated tape around the edges to the users face.

6. A mask that is rubber, plastic based. It is attached by clips to the back of the head. When the user/wearer opens his/her mouth a sound emanates from the device.

7. A mask that is rubber, plastic based. It has clips in the back to attach gently to the wearers head. It emits a light out of the mouth, when the user/wearer opens their mouth.

8. A mask that is rubber, plastic based. Worn over the face, it is attached with clips to the back of the head. When the user/wearer presses a button a sound emanates from the device.
